(19) United States
(12) Patent Application Publication
(10) Pub. No.: US 2016/0075033 A1
(43) Pub. Date: Mar. 17, 2016

(54) APPARATUS AND METHOD SWING SUPPRESSION IN AN AUTOMATED SYSTEM

(71) Applicant: Aesynt, Cranberry Township, PA (US)

(72) Inventors: Jason Soll, Pittsburgh, PA (US); Christopher L. Smith, Hermitage, PA (US)

(21) Appl. No.: 14/488,971

(22) Filed: Sep. 17, 2014

(51) Int. Cl. B25J 13/08; B25J 11/00; B25J 15/06

(52) U.S. Cl. CPC B25J 13/08; B25J 15/0616; B25J 11/00; B25J 15/0625

(57) ABSTRACT

Provided herein are various apparatuses, systems, and methods for suppressing swing in an automated system, such as an automated dispensing system. In particular, an apparatus may include an object retrieval arm configured to move within a workspace, an object retrieval head carried by the object retrieval arm, where the object retrieval head is configured to grasp a first end portion of an object, and at least one nozzle arranged proximate the object retrieval head, where the nozzle is directed toward a second end portion of the object. The apparatus may optionally include a controller configured to identify a swing condition and to cause a pulse of air to be blown from the at least one nozzle toward the object in response to identifying the swing condition. The swing condition may include an acceleration or deceleration rate above a predetermined value.

### BACKGROUND

Automated systems such as automated dispensing systems are commonly used to retrieve articles from a storage location, moving the articles to a dispensing location, and dispensing to an operator or to an automated transport system. Such automated dispensing systems may include package retrieval systems in a warehouse, part retrieval systems in a manufacturing facility, and automated medicine dispensing cabinets, robots, or systems commonly found in healthcare facilities for dispensing medications. Automated dispensing systems provide automated access to stored articles that are retrieved based upon a request from a user or a controller. The automated dispensing systems may operate more quickly than a person performing the same task and may also be more reliable and less error prone.

Although automated dispensing systems may provide faster and more reliable dispensing of articles, methods of improving throughput and reducing cycle time may be desirable to enhance the efficiencies provided by such automated dispensing systems.

### BRIEF SUMMARY

Methods and apparatuses for swing suppression in an automated system are provided for enhancing the efficiency of movement of objects in an automated system, such as an automated dispensing system. Embodiments of the apparatus and method may increase efficiency of an automated dispensing system by increasing the speed with which objects may be retrieved and moved throughout the system.

An example embodiment of an apparatus configured to suppress unwanted movement of a retrieved object may include an object retrieval arm configured to move within a workspace, an object retrieval head carried by the object retrieval arm, where the object retrieval head is configured to grasp a first end portion of an object, and at least one nozzle arranged proximate the object retrieval head, where the nozzle is directed toward a second end portion of the object. The apparatus may optionally include a controller configured to identify a swing condition and to cause a pulse of air to be blown from the at least one nozzle toward the object in response to identifying the swing condition. The swing condition may include an acceleration or deceleration rate above a predetermined value. The pulse of air may include a duration and a pressure, where at least one of the duration and the pressure is determined based upon the acceleration or deceleration rate. The controller may be further configured to identify a size of a retrieved object and/or a weight of the retrieved object. The controller may be configured to determine a propensity to swing of the retrieved object based on the size of the retrieved object and the weight of the retrieved object. The pulse of air may include a duration and a pressure, where at least one of the duration or pressure is configured to be determined based on a propensity to swing of the retrieved object.

According to some embodiments, the object retrieval head may include a first retrieval side and a second retrieval side, where each of the first retrieval side and the second retrieval side are configured to grasp an object, and where the at least one nozzle includes a first nozzle directed toward the first retrieval side of the object retrieval head and a second nozzle directed toward the second retrieval side of the object retrieval head. The object retrieval head may include one or more suction cups configured to engage and grasp an object to be retrieved. The one or more suction cups and the at least one nozzle may be operated by a single pneumatic pressure source. The apparatus may further include a valve, where the valve may be controlled by the controller to provide suction to the suction cups and to provide the pulse of air to the at least one nozzle.

Embodiments of the present invention may include a method including providing for retrieval of an object with an object retrieval head, moving the object with the object retrieval head, identifying a swing condition of the object, and causing a pulse of air to be blown from a nozzle toward the object in response to identifying the swing condition of the object. Identifying the swing condition may include identifying an acceleration or deceleration rate above a predetermined value. The pulse of air may include a duration and a pressure, where the method may include determining at least one of the duration or the pressure based upon the acceleration or deceleration rate. Example methods may include identifying a size of the object and/or identifying a weight of the object. The method may include determining at least one of the pressure or the duration based upon the size and/or weight of the object.

Embodiments of the present invention may include a computer program product with at least one non-transitory computer-readable storage medium, having computer-executable program code instructions stored therein. The computer-executable program code may include program code instructions to cause an object to be retrieved, program code instructions to determine a swing condition of the object, and program code instructions to cause a pulse of air to be blown from a nozzle toward the retrieved object. The program code instructions to determine a swing condition may include program code instructions to identify an acceleration or deceleration rate above a predetermined value. The program code instructions to cause a pulse of air to be blown from a nozzle toward the retrieved object may include program code instructions to determine a pressure and a duration of the air to be blown from the nozzle based, at least in part, on the acceleration or deceleration rate.

### BRIEF DESCRIPTION OF THE SEVERAL VIEWS OF THE DRAWINGS

Having thus described certain example embodiments of the invention in general terms, reference will now be made to the accompanying drawings, which are not necessarily drawn to scale, and wherein:

FIG. 1 illustrates an example embodiment of an automated dispensing system according to the present invention;

FIG. 2 illustrates a controller for an automated dispensing system according to an example embodiment of the present invention;

FIG. 3 illustrates an object which may be dispensed from an automated dispensing system according to example embodiments of the present invention;

FIG. 4 illustrates a retrieval head grasping an object according to an example embodiment of the present invention;

FIG. 5 illustrates a swing condition of an object grasped and moved by a retrieval head according to an example embodiment of the present invention;

FIG. 6 illustrates a swing suppression operation according to an example embodiment of the present invention; and

FIG. 7 is a flowchart of a method for swing suppression according to an example embodiment of the present invention.

### DETAILED DESCRIPTION

Embodiments of the present inventions now will be described more fully hereinafter with reference to the accompanying drawings, in which some, but not all embodiments of the inventions are shown. Indeed, embodiments of these inventions may be embodied in many different forms and should not be construed as limited to the embodiments set forth herein; rather, these embodiments are provided so that this disclosure will satisfy applicable legal requirements. Like reference numerals refer to like elements throughout.

Automated systems of embodiments of the present invention may be used in virtually any industry requiring the retrieval of specific articles from a storage location containing a plurality of articles and moving said articles to one or more locations. These systems are often implemented as automated dispensing systems where an order is “picked” from a supply and dispensed to a user, a manual transportation system (e.g., a user cart), or an automated transportation system (e.g., conveyors). Such applications may include distribution centers (e.g., an internet shopping shipping facility), manufacturing facilities, and healthcare facilities for retrieval of medications or medical supplies or equipment. While embodiments of the present invention may relate to a variety of industries and applications, and while automated systems of various types may implement embodiments of the present invention, example embodiments are generally illustrated and described herein in relation to an automated dispensing system in a healthcare facility.

Example embodiments of the automated dispensing systems of the present invention used by healthcare facilities may be used in facilities such as hospitals, physicians' offices, healthcare clinics, pharmacies, and any other facility that manages and/or dispenses drugs or medical supplies or equipment, particularly when dispensed on a patient-specific basis. The automated dispensing systems and methods described herein provide a streamlined and efficient way for healthcare professionals to interface with an automated storage device to dispense medications and supplies. Although nurses, pharmacists, pharmacist assistants, or technicians are often tasked with accessing medication stored in an automated dispensing system, and the example of a generic operator is used in the description that follows, it is understood that the described embodiments apply to any user who is interfacing with the automated dispensing system, including physicians, pharmacists, nurses, laboratory personnel, respiratory therapists, and others.

Automated dispensing systems may be controlled by a controller, such as a computer, that is configured to determine what articles are required to be dispensed, and in what order to dispense the articles. In the embodiment of an automated dispensing system for medications and supplies, the controller may be configured to determine the medications required for a particular patient or a plurality of patients and pick those medications from the stored medications. The medications may be picked on a per-patient basis and dispensed to a container for transport to the patient for use.

In an example embodiment of a conventional automated dispensing system, a robot, which may include an object retrieval arm and a retrieval head carried by the object retrieval arm, may pick medications for one patient at a time and unload the patient's medications to an output system, such as an envelope or bin that is situated in an output queue. In such an embodiment, the object retrieval arm including the object retrieval head may need to travel to and from the output queue for every patient and/or for every medication or supply retrieved. Some retrieved objects may be of a size and weight distribution which is prone to swinging during movement, such as an intravenous bag that is carried by an end of the bag by the object retrieval head may be prone to swinging upon sudden movements by the object retrieval arm. This propensity to swing may damage the medication or supply that is retrieved, and other medications, supplies, or components of the automated dispensing system may be damaged by swinging objects. In order to reduce the swinging of such objects during movement, the speed and acceleration rates of the object retrieval arm may be slowed. However, reducing the speed and acceleration rates of the object retrieval arm may reduce the efficiency of the automated dispensing system by reducing throughput.

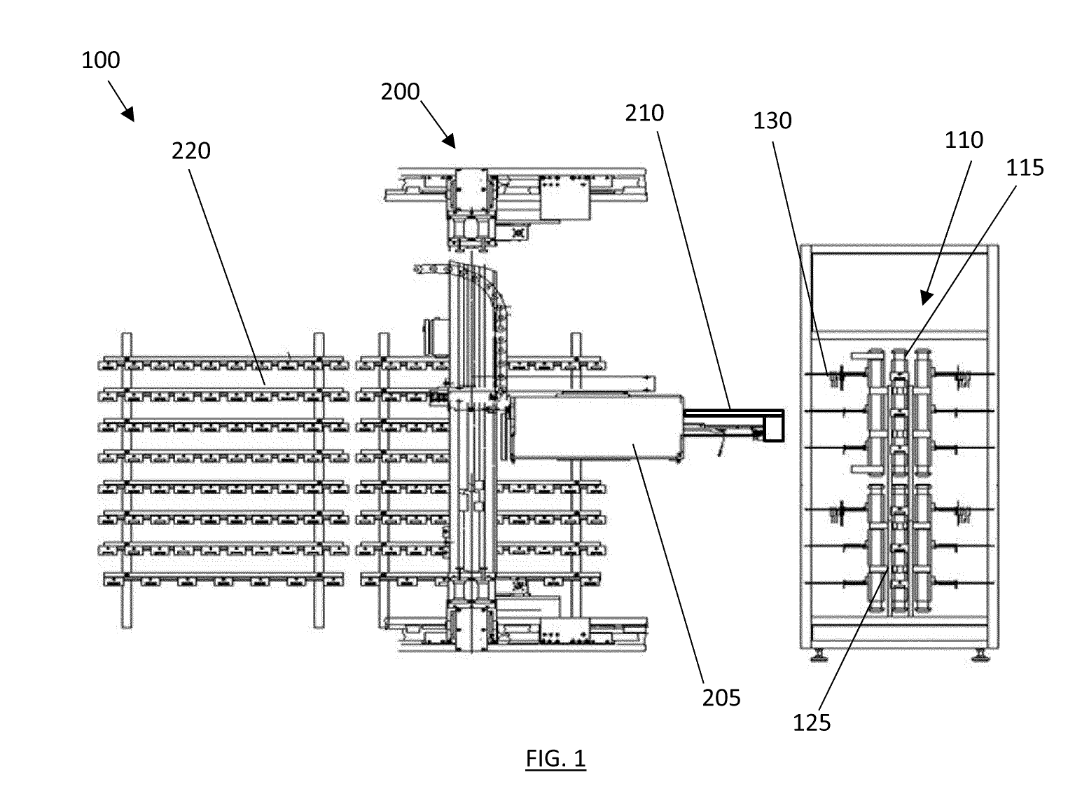

FIG. 1 illustrates an example embodiment of an automated dispensing system 100 including a robot 200 with an object retrieval arm 205 and an object retrieval head 210. The system further includes a carousel 110 with a plurality of carriers 130. The carousel 110 may include one or more levels, such as the two levels (115, 125) depicted in the illustrated embodiment. The carousel may be configured to rotate in order to present a carrier 130 at a given location accessible to the robot 200, as will be described further below. Each level of the carousel may be independently rotatable, or the levels of the carousel may be fixed relative to one another such that they rotate together.

The automated dispensing system may be configured to retrieve objects from a first location, such as stock rack 220, and dispense objects to a second location, such as carousel 110. Optionally, the second location may be a user (e.g., positioned at a retrieval station), an automated transport system, a manual transport system, etc. According to the illustrated embodiment, the robot 200 may be controlled by a controller (not shown), that receives an order for one or more objects. The controller may direct the robot 200 to retrieve the one or more objects and to dispense them to the carousel 110, or to another dispensing outlet as may be instructed by the controller.

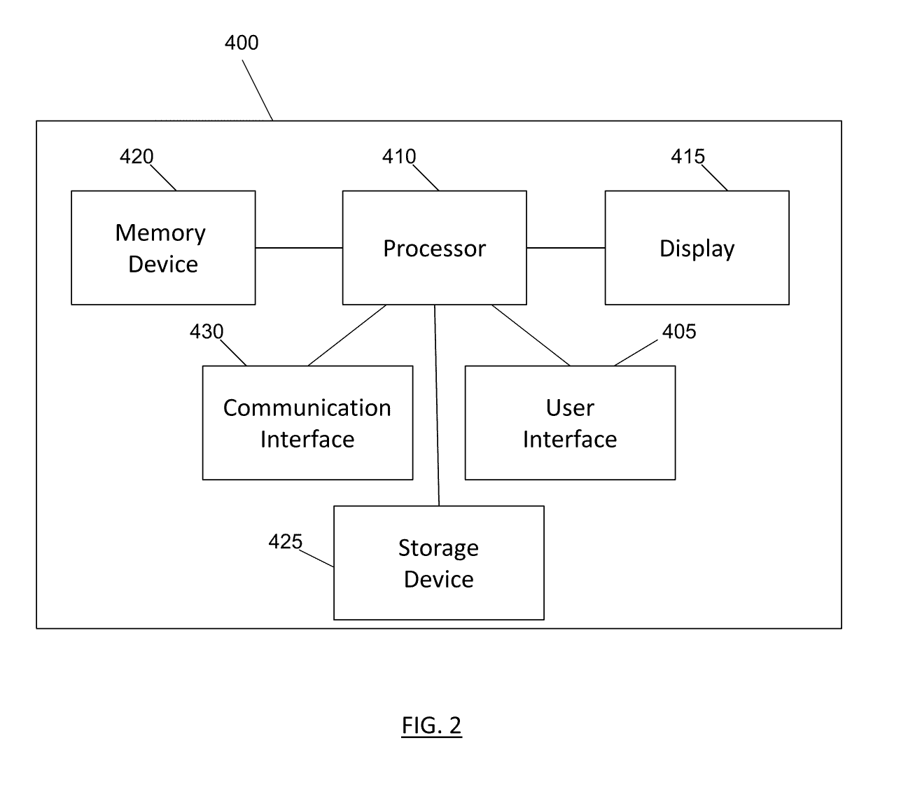

FIG. 2 provides a schematic of an automated dispensing system controller 400 according to one embodiment of the present invention which may be used to control the automated dispensing system 100. In general, the term “controller” may refer to, for example, any computer, computing device, mobile phone, desktop, tablet, notebook or laptop, distributed system, server, blade, gateway, switch, processing device, or combination of processing devices adapted to perform the functions described herein. The automated dispensing system controller 400 may include, be associated with, or be in communication with a variety of computing entities, such as pharmacy inventory management systems, medication dispensing units, data storage/facilitation computing entities, or other devices that may interface with inventory management, dispensing, replenishing, etc. While example embodiments of automated storage devices may be implemented in virtually any setting which may benefit from automated storage and the dispensing of articles, embodiments described herein will be described generally with respect to the field of healthcare in which medications, medical devices, and other articles may be dispensed in a healthcare facility. However, it is appreciated that embodiments of the present invention may apply to various other embodiments of automated storage systems and devices.

As will be understood from this figure, in one embodiment, the automated dispensing system controller 400 may include a processor 410 that communicates with other elements within the automated dispensing system controller 400 via a system interface or bus. The processor 410 may be embodied in a number of different ways. For example, the processor 410 may be embodied as a processing element, processing circuitry, a coprocessor, a controller or various other processing devices including integrated circuits such as, for example, an application specific integrated circuit (ASIC), a field programmable gate array (FPGA), a hardware accelerator, and/or the like.

In an exemplary embodiment, the processor 410 may be configured to execute instructions stored in memory or otherwise accessible to the processor 410. As such, whether configured by hardware or software methods, or by a combination thereof, the processor 410 may represent an entity capable of performing operations according to embodiments of the present invention when configured accordingly. For example, as discussed in more detail below, the automated dispensing system controller 400 may be configured, among other things, to receive medication or medical supply orders. A user interface 405 may be configured for user input of orders (medication, supplies, etc.) or to otherwise interact with existing orders. The user interface 405 may include a keyboard, a pointing device, or other mechanism for a user to communicate with the processor 410 and interact with the dispensing system controller 400. A display 415 may be configured to present information to a user pertaining to previous orders, current orders, or future orders for medication or supplies. The display 415 may also be configured to present information to a user pertaining to the status of the automated dispensing device, information regarding inventory, or any information which may be useful to a user of the device. The display 415 may include a touch screen display which may partially or fully comprise the user interface 405.

The automated dispensing system controller 400 may further include transitory and non-transitory memory device 420, which may include both random access memory (RAM) and read only memory (ROM). The ROM may be used to store a basic input/output system (BIOS) containing the basic routines that help to transfer information to the different elements within the automated dispensing system controller 400.

In addition, in one embodiment, the automated dispensing system controller 400 may include at least one storage device 425, such as a hard disk drive, a CD drive, and/or an optical disk drive for storing information on various computer-readable media. The storage device(s) 425 and its associated computer-readable media may provide nonvolatile storage. The computer-readable media described above could be replaced by any other type of computer-readable media, such as embedded or removable multimedia memory cards (MMCs), secure digital (SD) memory cards, Memory Sticks, electrically erasable programmable read-only memory (EEPROM), flash memory, hard disk, and/or the like.

Furthermore, a number of executable instructions, applications, scripts, program modules, and/or the like may be stored by the various storage devices 425 and/or within memory device 420. As discussed in more detail below, these executable instructions, applications, program modules, and/or the like may control certain aspects of the operation of the automated storage device controller 400 with the assistance of the processor 410 and operating system, although their functionality need not be modularized. In addition to the program modules, the automated storage device controller 400 may store or be in communication with one or more databases.

Also located within the dispensing system controller 400, in one embodiment, is a communication interface 430 for interfacing with various computing entities. This communication may be via the same or different wired or wireless networks (or a combination of wired and wireless networks). For instance, the communication may be executed using a wired data transmission protocol, such as fiber distributed data interface (FDDI), digital subscriber line (DSL), Ethernet, asynchronous transfer mode (ATM), frame relay, data over cable service interface specification (DOCSIS), or any other wired transmission protocol. Similarly, the automated storage device controller 100 may be configured to communicate via wireless external communication networks using any of a variety of protocols, such as 802.11, general packet radio service (GPRS), Universal Mobile Telecommunications System (UMTS), Code Division Multiple Access 2000 (CDMA2000), CDMA2000 1× (1×RTT), Wideband Code Division Multiple Access (WCDMA), Time Division-Synchronous Code Division Multiple Access (TD-SCDMA), Long Term Evolution (LTE), Evolved Universal Terrestrial Radio Access Network (E-UTRAN), Evolution-Data Optimized (EVDO), High Speed Packet Access (HSPA), High-Speed Downlink Packet Access (HSDPA), IEEE 802.11 (Wi-Fi), 802.16 (WiMAX), ultra wideband (UWB), infrared (IR) protocols, Bluetooth™ protocols, wireless universal serial bus (USB) protocols, and/or any other wireless protocol.

It will be appreciated that one or more of the automated dispensing system controller's 400 components may be located remotely from other dispensing system controller 400 components. Furthermore, one or more of the components may be combined and additional components performing functions described herein may be included in the automated dispensing system controller 400.

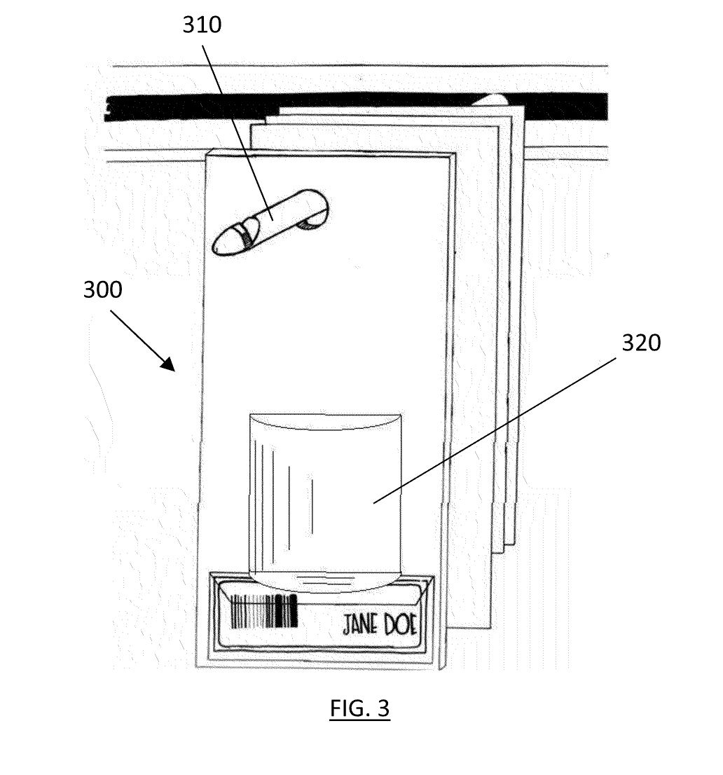

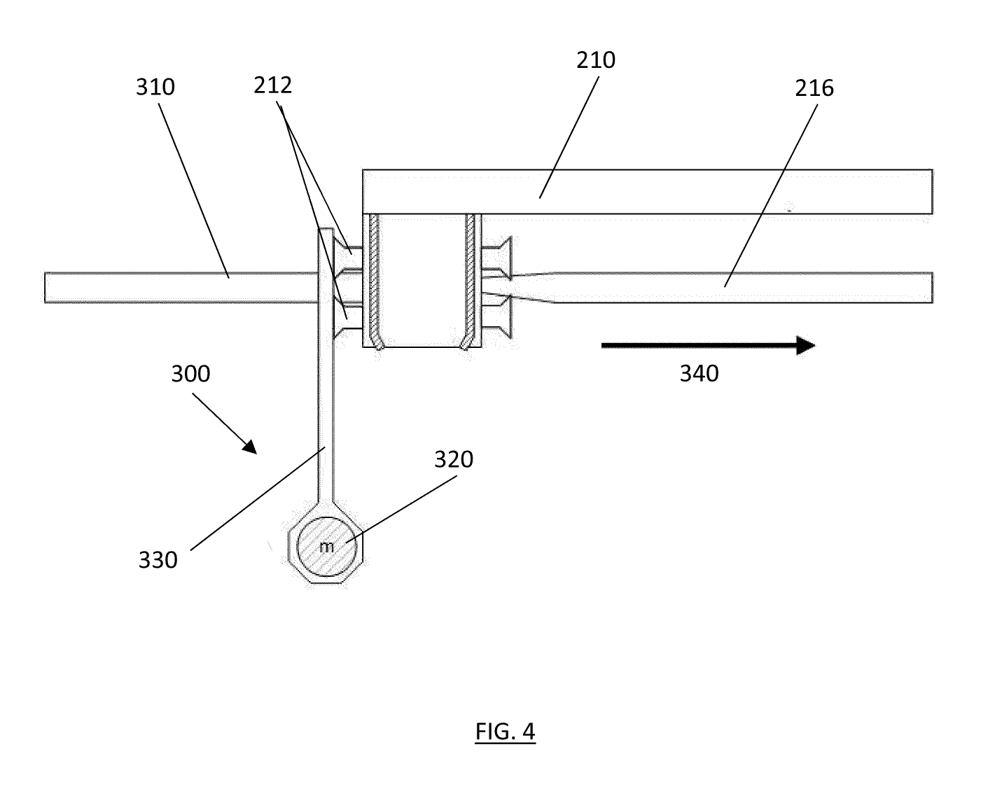

FIG. 3 illustrates an example embodiment of an object which may be retrieved using the automated dispensing system of FIG. 1. The illustrated object 300 is suspended on rod 310 and may include contents suspended in cavity 320. These contents include a mass center which may be substantially offset from the location at which the object is suspended. FIG. 4 illustrates the object 300 on rod 310, with the retrieval head 210 of the robot advancing to retrieve the object 300. The illustrated embodiment of the retrieval head 210 may include suction cups 212 configured to engage the object 300 and grasp the object to the retrieval head 210. As shown, the retrieval head 210 may include a rod 216 configured to receive the retrieved object 300. The object may have a low center of mass 320 relative to the packaging 330, which may be relatively flexible. While the illustrated retrieval head 210 includes suction cups 212, any means of grasping may be used to secure the object 300 to the retrieval head 210.

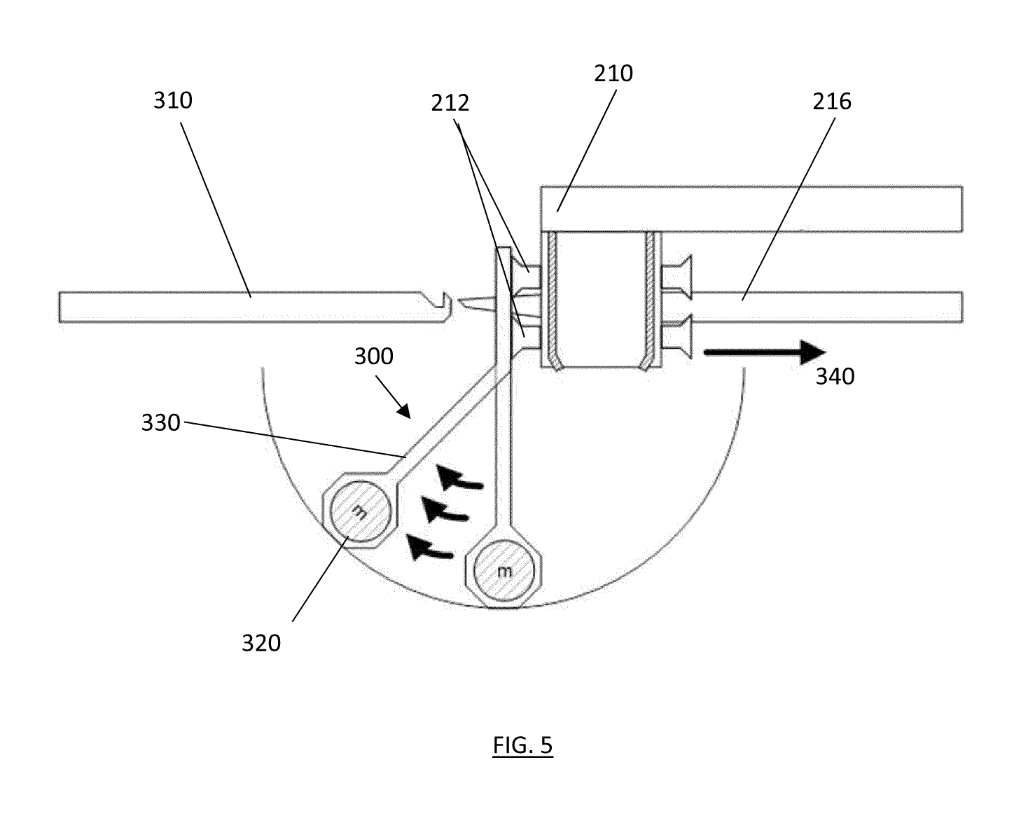

Once the retrieval head 210 has grasped the object 300, the retrieval head 210 may move in the direction of arrow 340. This may draw the object onto transport rod 216. The acceleration of the retrieval head along the direction of arrow 340 may cause the retrieved object 300 to swing, as shown in FIG. 5. This swinging motion may be exacerbated by high acceleration rates of the retrieval head 210, by the length of the packaging 330, and by the weight distribution of the object 300. For example, if the packaging is relatively long (i.e., extending away from the rod 310), and the object has a mass 320 concentrated proximate the lower extent of the object 300, the object may have a greater propensity to swing.

While the swinging of an object, as illustrated in FIG. 5, can be reduced by virtue of a reduction in the acceleration of the retrieval head 210 and the robot 200 as it moves the retrieved object 300, slowing of the robot 200 and retrieval head 210 would lower the efficiency with which the automated dispensing system operates. Thus, embodiments of the present invention are configured to reduce or suppress the swinging of a retrieved object without compromising the efficiency of operation of the automated dispensing system.

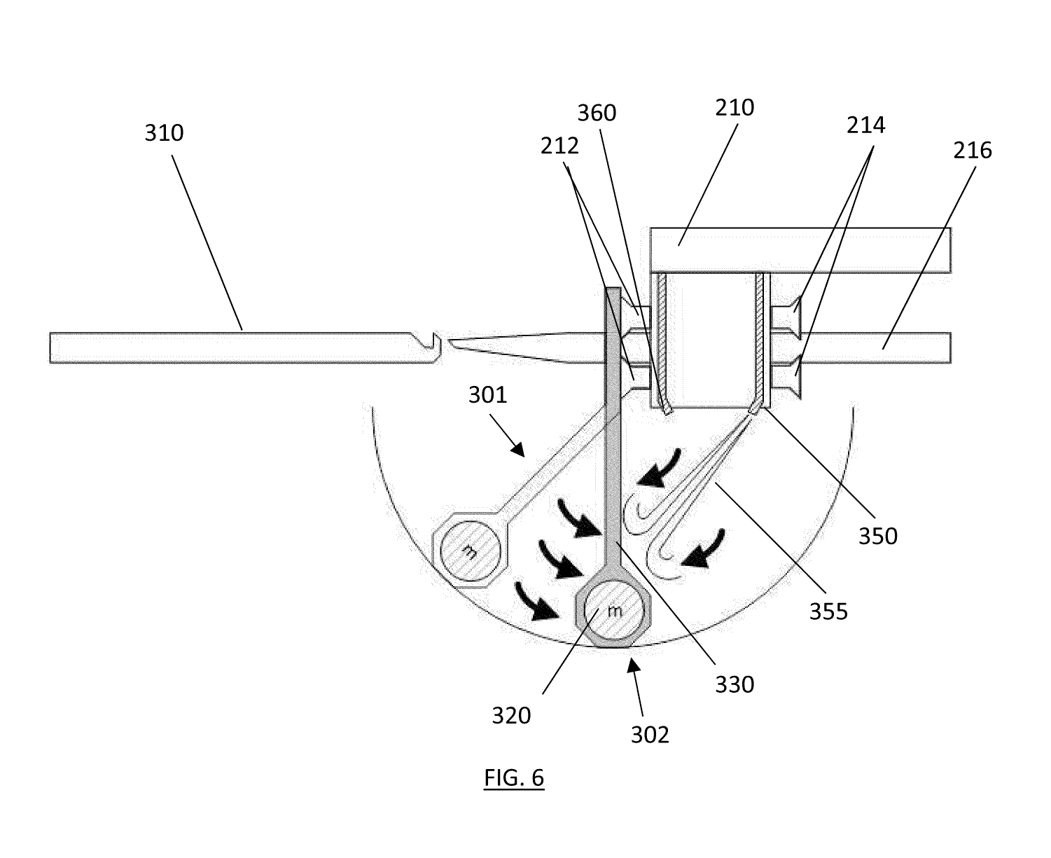

FIG. 6 illustrates an example embodiment of the apparatus for swing suppression in which the object 300 has been advanced in the direction of arrow 340 of FIG. 5 with an acceleration rate that leads to a swing condition. The swing condition illustrated in FIG. 6 shows the object in a swinging state 301 caused by the acceleration of the retrieval head 210. This swing state may continue to swing in a pendulum motion absent any intervention or additional acceleration. This swinging motion may damage the object 300, the packaging 330, the retrieval head 210, or otherwise impede efficient automated dispensing. FIG. 6 further depicts a swing suppression system including a nozzle 350 configured to blow a stream of air 355 toward the object 300 to arrest the swing condition and steady the object in an arrested position 302. This stream of air 355 may be pressurized air configured to produce a force on the object 300 to counter-act the swing state. Thus, the nozzle 350 may be directed toward an object positioned on a first side of the retrieval head 210, grasped by suction cups 212. This nozzle may direct air toward the object 300 as it swings toward the nozzle, thus decelerating the object and suppressing the swing state.

According to some embodiments, as illustrated in FIG. 6, the retrieval head 210 may also include a second set of suction cups 214 arranged to grasp an object on the opposite side of the retrieval head 210. In such an embodiment, a second nozzle 360 may be provided to suppress a swing condition of an object grasped by the second set of suction cups 214.

As objects may have various sizes and weights, objects of different types may be prone to different swing conditions. Longer, flexible packaging with a weight disposed toward an end away from the suspended end of the package may be prone to a greater swing condition than an object with shorter packaging, less weight, or less flexible packaging. Accordingly, the force needed to suppress a swing condition may differ from one object to another. Further, the acceleration rate of the retrieval head 210 may influence the swing condition magnitude. According to embodiments of the present invention, the controller 400 may be configured to adjust a pressure and/or duration of the stream of air 355 according to a determined magnitude of a determined swing condition, based on the propensity of an object to swing.

A swing condition may be identified based on the acceleration rate of the retrieval head 210 and a swing magnitude may be determined based upon the packaging size and configuration. The packaging size and configuration may be obtained from a database, such as a table indicative of the packaging size and configuration of a specific object that is to be retrieved. Optionally, the controller 400 may be configured to determine packaging size and configuration based upon one or more sensors arranged proximate the retrieval head 210. For example, an optical sensor may be able to determine a packaging size and/or configuration, while a weight sensor or strain gage may be configured to determine packaging weight on rod 216. In this manner, the controller 400 may be able to use the packaging size and orientation, together with the acceleration rate of the retrieval head 210 to determine the magnitude of a swing condition, and to adjust the pressure and/or duration of the stream of air 355 accordingly.

The magnitude of the swing condition may be proportional to the packaging size/weight/orientation and the acceleration rate. In an example embodiment in which the packaging was elongated, with the mass-center disposed proximate an end of the package opposite the end suspended by the rod 310, as illustrated in FIGS. 4-6, the propensity to swing may be enhanced, and combined with the acceleration rate, the magnitude of the swing condition may be relatively high. Conversely, if a package was relatively short, with the mass center disposed close to the area of the package grasped by the retrieval head 210, the propensity to swing may be relatively low, and the acceleration rate may not substantially affect the magnitude of the swing condition. With varying packaging sizes, weights, and orientations, the propensity to swing may be widely varied from very low to very high. Acceleration rates will have a greater effect on packaging sizes, weights, and orientations that have a high propensity to swing, thereby increasing the magnitude of the swing condition.

The increase in propensity to swing, and the increasing magnitude of the swing condition may be determined by the controller 400. The controller 400 may determine the package size, orientation, and weight as described above, and determine a propensity to swing from this information. The propensity to swing and the acceleration rates of the retrieval head 210 may be used to determine a magnitude of the swing condition of a package. This magnitude may be used by the controller 400 to vary the parameters of the pulse of air expelled from nozzle 350 of FIG. 6. For example, the determination of a relatively high-magnitude swing condition may cause a longer pulse of air and/or a higher pressure pulse of air to be expelled from nozzle 350. Conversely, the determination of a relatively low-magnitude swing condition by the controller 400 may result in the controller directing a shorter pulse of air and/or a lower pressure pulse of air to be expelled from nozzle 350.

According to some embodiments, the magnitude of the swing condition may be determined to be negligible such that no swing suppression is necessary. For example, if a propensity to swing is determined by the controller 400 to be low, such as when a package is relatively small and the center of mass is close to the retrieval head 210, the controller may ascertain that the propensity to swing is low. Thus, with an acceleration rate below a predefined value, no swing suppression may be necessary. The acceleration rate may be determined based on the absolute value of the movement of the retrieval head 210 such that acceleration rate may, in fact, be an increase in speed or a decrease in speed, both of which may contribute to a swing condition magnitude. However, when an acceleration rate satisfies a predetermined criteria, such as when the acceleration rate (or absolute value thereof) is above a predefined value, swing suppression methods according to example embodiments herein may be implemented.

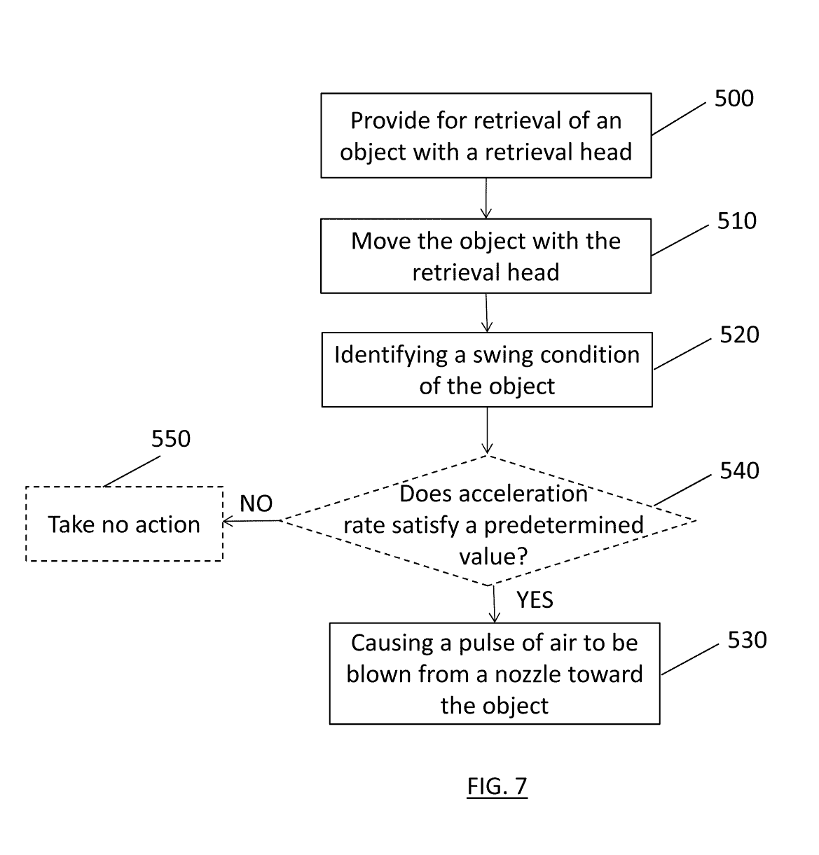

FIG. 7 is a flowchart of a method and program product according to an example embodiment of the present invention. It will be understood that each block of the flowchart and combinations of blocks in the flowchart may be implemented by various means, such as hardware, firmware, processor, circuitry, and/or other devices associated with execution of software including one or more computer program instructions. These computer program instructions may also be stored in a non-transitory computer-readable memory that may direct a computer or other programmable apparatus to function in a particular manner, such that the instructions stored in the computer-readable memory produce an article of manufacture which implements the functions specified in the flowchart blocks. The computer program instructions may also be loaded onto a computer or other programmable apparatus to cause a series of operations to be performed on the computer or other programmable apparatus to produce a computer-implemented process such that the instructions which execute on the computer or other programmable apparatus implement the functions specified in the flowchart blocks.

Accordingly, blocks of the flowchart support combinations of means for performing the specified functions and combinations of operations for performing the specified functions. It will also be understood that one or more blocks of the flowchart, and combinations of blocks in the flowchart, can be implemented by special purpose hardware-based computer systems which perform the specified functions, or combinations of special purpose hardware and computer instructions.

In this regard, a method according to one embodiment of the invention, as shown in FIG. 7, may include providing for retrieval of an object with a retrieval head at 500, moving the object with the retrieval head at 510, identifying a swing condition of the object at 520, and causing a pulse of air to be blown from a nozzle toward the object at 530. The pulse of air may be caused in response to the identification of a swing condition at 520, which may be identified, for example, by controller 400.

In some embodiments, certain ones of the operations may be modified or further amplified as described below. Moreover, in some embodiments additional operations may also be included. It should be appreciated that each of the modifications, optional additions, or amplifications below may be included with the operations above either alone or in combination with any others among the features described herein. With reference to the method of FIG. 7, in some example embodiments, identifying a swing condition of the object at 520 may include identifying if an acceleration rate of the retrieval head satisfies a predetermined value, as shown at 540. If the acceleration rate is below a predetermined value, at 550, no action with regard to swing suppression may be taken as the magnitude of the swing condition may be negligible. If the acceleration rate is above the predetermined value at 530, the duration and pressure of a pulse of air delivered at may be determined, at least in part, upon the acceleration rate identified in 540.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation.

That which is claimed:

1. An apparatus comprising:
an object retrieval arm configured to move within a workspace;
an object retrieval head carried by the object retrieval arm, wherein the object retrieval head is configured to grasp a first end portion of an object;
at least one nozzle arranged proximate the object retrieval head, wherein the nozzle is directed toward a second end portion of the object; and
a controller configured to identify a swing condition and to cause a pulse of air to be blown from the at least one nozzle toward the object in response to identifying a swing condition.

2. The apparatus of claim 1, wherein the swing condition comprises an acceleration or deceleration rate that satisfies a predetermined value.

3. The apparatus of claim 2, wherein the pulse of air comprises a duration and a pressure, wherein at least one of the duration and the pressure are determined based upon the acceleration or deceleration rate.

4. The apparatus of claim 1, wherein the controller is further configured to identify a size of a retrieved object.

5. The apparatus of claim 4, wherein the controller is further configured to identify a weight of the retrieved object.

6. The apparatus of claim 5, wherein the controller is configured to determine a propensity to swing of the retrieved object based on the size of the retrieved object and the weight of the retrieved object.

7. The apparatus of claim 6, wherein the pulse of air comprises a duration and a pressure, and wherein at least one of the duration or the pressure is configured to be determined based on the propensity to swing of the retrieved object.

8. The apparatus of claim 1, wherein the object retrieval head comprises a first retrieval side and a second retrieval side, wherein each of the first retrieval side and the second retrieval side are configured to grasp an object, and wherein the at least one nozzle comprises a first nozzle directed toward the first retrieval side of the object retrieval head and a second nozzle directed toward the second retrieval side of the object retrieval head.

9. The apparatus of claim 1, wherein the object retrieval head comprises one or more suction cups configured to engage and grasp an object to be retrieved.

10. The apparatus of claim 9, wherein the one or more suction cups and the at least one nozzle are operated by a single pneumatic pressure source.

11. The apparatus of claim 10, further comprising a valve, wherein the valve is controlled by the controller to provide suction to the suction cups and to provide the pulse of air to the at least one nozzle.

12. A method comprising:
providing for retrieval of an object with a retrieval head;
moving the object with the retrieval head;
identifying a swing condition of the object; and
causing a pulse of air to be blown from a nozzle toward the object in response to identifying the swing condition of the object.

13. The method of claim 12, wherein identifying the swing condition comprises identifying an acceleration or deceleration rate that satisfies a predetermined value.

14. The method of claim 13, wherein the pulse of air comprises a duration and a pressure, the method further comprising determining at least one of the duration or the pressure based upon the acceleration or deceleration rate.

15. The method of claim 12, further comprising identifying a size of the object.

16. The method of claim 15, further comprising identifying a weight of the object.

17. The method of claim 16, wherein the pulse of air comprises a duration and a pressure, wherein the method further comprises determining at least one of the pressure or the duration based upon at least one of the size or the weight of the object.

18. A computer program product comprising at least one non-transitory computer-readable storage medium, having computer-executable program code instructions stored therein, the computer-executable program code instructions comprising:
program code instructions to cause an object to be retrieved;
program code instructions to cause an object to be moved;
program code instructions to determine a swing condition of the object; and
program code instructions to cause a pulse of air to be blown from a nozzle toward the retrieved object.

19. The computer program product of claim 18, wherein the program code instructions to determine a swing condition comprise program code instructions to identify an acceleration or deceleration rate that satisfies a predetermined value.

20. The computer program product of claim 19, wherein the program code instructions to cause a pulse of air to be blown from a nozzle toward the retrieved object comprise program code instructions to determine a pressure and a duration of the air to be blown from the nozzle based on the acceleration or deceleration rate.
